(19) United States
(12) Patent Application Publication
(10) Pub. No.: US 2017/0203969 A1
(43) Pub. Date: Jul. 20, 2017

(54) METHOD FOR FORMING A GRAPHENE BASED MATERIAL AND A PRODUCT

(71) Applicant: Aalto University Foundation, Aalto (FI)

(72) Inventors: Le Hoang SINH, Aalto (FI); Nguyen Dang LUONG, Aalto (FI); Jukka SEPPÄLÄ, Aalto (FI)

(21) Appl. No.: 15/324,931

(22) PCT Filed: Jul. 9, 2015
(86) PCT No.: PCT/FI2015/050498

§ 371 Date: Jan. 9, 2017

Related U.S. Application Data
(60) Provisional application No. 62/022,228, filed on Jul. 9, 2014.

(51) Int. Cl. C07C 319/18; C02F 5/08

(52) U.S. Cl. CPC C01B 31/0446; C01B 31/043; B82Y 40/00

(57) ABSTRACT

The invention relates to a method for forming graphene based material. According to the invention graphene oxide is functionalized via thiol-ene click chemistry so that the graphene oxide is prepared and dispersed in solvents, the graphene is reacted with thiol containing compound via thiol-ene click reaction between thiol group and double bond of aromatic rings in graphene oxide by one-step reaction, and the functionalized graphene oxide is formed. Further, the invention relates to a product.

### FIELD OF THE INVENTION

The invention relates to a method and a product defined in this description and claims.

### BACKGROUND OF THE INVENTION

Graphene is an atom-thick crystal of sp²-bonded carbon atoms arranged in a hexagonal lattice, which was reported for its existence the first time in 2004. It has shown many extraordinary properties, such as high thermal conductivity (˜5000 W/mK), fast charged carrier mobility (˜200 000 cm² V⁻¹ s⁻¹), high Young's modulus (˜1 TPa), and huge surface area (2630 m² g⁻¹). Graphene has been widely considered as the most famous researched material in the last decade owing to its exceptional physical properties and tunable chemistry as mentioned above. However, due to its high inertness, graphene needs to be chemically modified/functionalized for many applications, especially energy storages, such as electrodes in supercapacitors and batteries, catalyst supporters in fuel cells, and reinforcements in functional composites. The chemical modifications of graphene and its derivatives have been done so far including nucleophilic addition, cycloaddition, free radical addition, substitution, and rearrangement reactions. Special attentions have been given to the modifications of graphene oxide via the oxygen functionalities; however, the effectiveness of modifications is limited due to low density/chemical activity of these oxygen-containing groups.

Tailoring the electronic arrangement of graphene by doping with sulfur or nitrogen is a practical strategy for improving oxygen-reduction reaction in fuel cells. In this regard, chemical modification resulted in the doping of graphene, which is known as chemical doping. In the last few years, doped graphene materials have been attracted tremendous attention in graphene modification for catalyst purposes. Doping of graphene is an efficient way to tailor the chemical, electrical and catalyst properties of graphene materials. Doping of graphene with different atoms such as B, N, and S results in the disruption of the sp²carbon network and thus leading to changes in the chemical and physical properties of graphene. The electronic properties could be controlled by the doping level, for example, the metallic nature of graphene can be converted to a semiconductor behavior. Chemical doping of graphene has been proved as promising way because it does not significantly change the mobility in graphene.

Furthermore, depending on the functional groups that are covalently bonded to the graphene network, the graphene solubility in both organic and inorganic media could also be achieved. It should be noted that special attentions have been given to S-doped and N-doped graphene owing to their effectiveness in catalytic activities in fuel cells. For example, doping of sulfur onto graphene sheets resulted in enhancement of catalyst performance in oxygen reduction in fuel cell. It has been reported that the reversible discharge capacity of N-doped graphene is about two times higher than that of the pristine graphene. However, their practical applications are limited due to the use of expensive equipment such as chemical vapor deposition and/or harsh experimental conditions such as high temperature and low yield. Very recently, few papers reported that the dual doping of both sulfur and nitrogen or boron and nitrogen into the graphene lead to synergistic effect in improvement of electrocatalyst performance for oxygen reduction. However, again, these methods show many limitations, such as harsh reaction condition, toxic chemical, and/or expensive equipment.

### SUMMARY OF THE INVENTION

Graphene oxide (GO) has been chemically modified using thiol-ene click reaction resulted in the formation of nitrogen-sulfur dual doped graphene (NS-GO). The NS-GO can be reduced to electrically conductive and functional graphene (NS-rGO). It needs to address that the method neither require high temperature for reaction nor expensive equipment to perform reaction. To our knowledge, this is the first time such highly functional graphene has been made.

The doping levels of the sulfur-nitrogen in the graphene can be adjusted depending on the applications. For example, cysteamine which contains amine groups was used to modify GO to create well-dispersed NS-GO sheets in several common and non-toxic solvents, e.g., water, ethanol, and ethylene glycol.

These dispersions can be processed into variety of graphene-based materials. As an example, NS-rGO was proved as excellent host matrix for metal nanoparticles such as platinum nanoparticles, which can be used as catalyst in fuel cells.

Moreover, the developed NS-GO and NS-rGO can be used as electrical/mechanical reinforcement in polymer composites, especially for polyimide, polyaniline and polyamides.

Different from all mentioned above methods of the prior art, in this work, we have successfully employed thiol-ene click reaction to functionalize graphene oxide. To our best knowledge, this is the first time thiol-ene modification of graphene has been achieved. The thiol-ene click reactions offer many advantages including high regioselectivity, mild reaction conditions, and high conversion, etc. By this chemistry, both sulfur and nitrogen atoms are able to be doped on graphene surface in one reaction, for example, using cysteamine hydrochloride (HS—(CH)₂—NH₂HCl) as the reagent in the reaction. The presence of nitrogen and sulfur atoms can play as anchoring sites to absorb and stabilize the nanoparticles on the graphene surface. Thus, the functional graphene can be a good supporter for nanoparticle catalysts, such as platinum, palladium, copper, etc. It should be emphasized that in the click reaction, the thiol compounds can be added to every double bond in carbon network leading to extremely high functional groups on graphene surface which are difficult obtained otherwise. This developed method could be further applied to many other functional groups as long as the reagents containing thiol moieties. Different functionalities and their levels can be controlled by changing of thiol agents and reaction parameters.

Furthermore, many active functional groups can also be added to alter the graphene properties for the desired applications. Interestingly, with using multifunction amine and thiol groups of thiol containing agents, we can introduce more than one dopant atoms by generating only one defect on sp² carbon network of graphene. Additionally, some synergistic effects can be found with the specific doping sites of dopant atoms, which can be controlled easily via the click chemistry by changing the chemical structure of segment between thiol group and amine group. Our method is based on the use of graphite oxide which is from oxidation of natural graphite. As known, graphite is reasonably cheap and abundant material and has been commercialized for so long time. Additionally, the thiol click reaction could be carried out in water and at low temperature (eg. 60° C.), thus avoiding the use of toxic/expensive solvents and reducing power consumption. Especially, the NS-GO materials can be dispersed well in eco-friendly media, such as water, ethanol, and ethylene glycol. With above advantages, our method can be the best route to produce industrial scale of varied functional graphenes in high economic efficiency. The resulted graphene can be used as catalyst supporter in energy storages, sensors, and polymer composites.

### LIST OF FIGURES

In the following section, the invention will be described with the aid of detailed exemplary embodiments, referring to the accompanying figures.

FIG. 1 presents general structure of thiol containing compounds.

FIG. 2 presents preparation of functional graphene via thiol-ene click chemistry: Thiol-ene reaction, which is hydrothiolation of a C═C bond with anti-Markovnikov regioselectivity orientation (a), synthetic route for graphene mofication via thiol-ene click reaction (b), and an example of sulfur and nitrogen dual doping on graphene structure using cysteamine hydrochloride (c).

FIG. 3 presents schematic demonstrating the chemical structure of NS-GO material obtained via thiol-ene click reaction. The obtained NS-GO can then be reduced to form electrically conductive, namely NS-reduced-GO (NS-rGO).

FIG. 4 presents preparation route for functional graphene by thiol-ene click chemistry and preparation of functional/conductive NS-rGO/Pt composite.

FIG. 5 presents NS-GO dispersion in water (3 mg mL⁻¹), NS-GO film with a thickness of around 10 μm, NS-GO fiber mats on polyurethane (left) and a polytetrafluoroethylene (right) substrates (a). These graphene mats were prepared by “hand writing” the NS-GO dispersion. TEM image of NS-rGO-DWCNT/Pt nanocomposite (38 wt % of Pt content). XPS data for the NS-GO sample which shows both N and S presence in the graphene structure (c).

FIG. 6 presents TEM images of DWCNT/NS-GO/Pt composites (low doping, a-c) and DWCNT/NS-GO/Pt (high doping, e-f), both containing 38 wt % of Pt nanoparticles.

### DETAILED DESCRIPTION OF THE INVENTION

### Example 1

### Preparation Graphene Oxide

Graphite oxide was prepared to a modified Hummers' method described by Luong N D, Hippi U, Korhonen J T et al., Enhanced mechanical and electrical properties of polyimide film by graphene sheets via in situ polymerization, Polymer, 2011;52(23):5237-5242, and Patel M U M, Luong N D, Seppälä J, Low surface area graphene/cellulose composite as a host matrix for lithium sulphur batteries, J Power Sources, 2014;254(15):55-61. The graphite oxide was ultrasonicated in water to obtain GO dispersion with a solid content of 5 mg mL⁻¹.GO dispersion was freeze-dried and subsequently vacuum-dried to obtain dried-GO power.

### Example 2

### Preparation of Functional GO by Thiol-ene Click Chemistry in N,N-Dimethylformamide (DMF) Solvent and Using 2,2-Azobis(2-methylpropionitrile) (AIBN) as Thermal Initiator

GO (powder) was ultrasonicated in N,N-Dimethylformamide (DMF) solvent for 30 min, which was then filled in three-necked round bottom flask reactor equipped with a magnetic stirrer. Nitrogen bubbling was carried for 30 min to introduce inert environment. The solution of 2,2-Azobis(2-methylpropionitrile) (AIBN, initiator) and cysteamine hydrochloride in 5 ml of DMF was injected to the reaction mixture. Nitrogen bubbling was continued for 30 min. The reaction mixture was heated to 70° C. using oil bath and hold for 12 h. The reaction was cooled down to room temperature and a solution of NaOH (1M) in ethanol/water (15/5 mL) was added to the mixture while stirring. The mixture was washed by vacuum filtration to eliminate impurities for 5 times with ethanol (2 times) and water (3 times). The product obtained after freeze-dried and vacuum dried at 60° C. to remove water. The nitrogen and sulfur doping level in the product is controlled by varying the cysteamine hydrochloride or other similarities used in the synthesis.

### Example 3

### Preparation of Functional GO by Thiol-ene Click Chemistry in Deionized Water and Using Water Soluble 4,4-azobis(4-cyano valeric acid) (ACVA) as Thermal Initiator

GO (powder) was ultrasonicated in Deionized water (DI water) for 30 min, which was then filled in three-necked round bottom flask reactor equipped with a magnetic stirrer. Nitrogen bubbling was carried for 30 min to introduce inert environment. The solution of 4,4-azobis(4-cyano valeric acid) (ACVA, initiator) and cysteamine hydrochloride in 5 ml of DI water was injected to the reaction mixture. Nitrogen bubbling was continued for 30 min. The reaction mixture was heated to 70° C. using oil bath and hold for 12 h. The reaction was cooled down to room temperature and a solution of NaOH (1M) in ethanol/water (15/5 mL) was added to the mixture while stirring. The mixture was washed by vacuum filtration to eliminate impurities for 5 times with ethanol (2 times) and water (3 times). The product obtained after freeze-dried and vacuum dried at 60° C. to remove water. The nitrogen and sulfur doping level in the product is controlled by varying the cysteamine hydrochloride or other similarities used in the synthesis.

### Example 4

### Preparation of Functional GO by Thiol-ene Click Chemistry in N,N-Dimethylformamide (DMF) and Using 2,2-dimethoxy-2-phenylacatophenone (DMPA) Photoinitiator under UV Radiation

GO (powder) was ultrasonicated in N,N-Dimethylformamide (DMF) for 30 min, which was then filled in 100 mL Schlenk flask equipped with a magnetis stirrer. The solution of 2,2-dimethoxy-2phenylacatophenone (DMPA) and cysteamine hydrochloride in 5 ml of DMF was injected to the reaction mixture. Residue oxygen was removed thoroughly by using three freeze-pump-thaw cycles or nitrogen bubbling for 30 min. The reaction mixture was radiated with UV at wavelength of 254-365 nm for 6 h. A solution of NaOH (1M) in ethanol/water (15/5 mL) was added to the mixture while stirring. The mixture was washed by vacuum filtration to eliminate impurities for 5 times with ethanol (2 times) and water (3 times). The product obtained after freeze-dried and vacuum dried at 60° C. to remove water. The nitrogen and sulfur doping level in the product is controlled by varying the cysteamine hydrochloride or other similarities used in the synthesis.

### Example 5

### Preparation of Functional GO by Thiol-ene Click Chemistry in Deionized Water and Using Eosin Y Disodium Salt Photoinitiator Under Visible Light Radiation

GO (powder) was ultrasonicated in Deionized water for 30 min, which was then filled in 100 mL Schlenk flask equipped with a magnetic stirrer. The solution of Eosin Y disodium salt and cysteamine hydrochloride in 5 ml of Deionized water was injected to the reaction mixture. Residue oxygen was removed thoroughly by using three freeze-pump-thaw cycles or nitrogen bubbling for 30 min. The reaction mixture was radiated with visible light at wavelength of 500-600 nm for 6 h. A solution of NaOH (1M) in ethanol/water (15/5 mL) was added to the mixture while stirring. The mixture was washed by vacuum filtration to eliminate impurities for 5 times with ethanol (2 times) and water (3 times). The product obtained after freeze-dried and vacuum dried at 60° C. to remove water. The nitrogen and sulfur doping level in the product is controlled by varying the cysteamine hydrochloride or other similarities used in the synthesis.

### Example 6

### Preparation of Electrically Conductive NS-rGO/Pt Composite for Catalyst Application in Fuel Cells

NS-GO, 100 mg, was dispersed in ethylene glycol (EG) with a concentration of 1.2 mg mL⁻¹. This mixture was treated with ultrasonic for 30 min to introduce good dispersion of NS-GO sheets in the solvent. The mixture was supplied to a three-neck round bottom flask equipped with a magnetic stirring. Nitrogen bubbling was carried out for 30 min. After that, an amount of H₂PtCl₆ which was pre-dissolved in 5 mL EG was injected to the solution. The amount of the salt was calculated with the Pt content is 38 wt % compared to that of the graphene amount. After 30 min nitrogen bubbling, the solution was heated to 140° C. for 4h. The solution was cooled down to room temperature. An amount of 100 μl of hydrazine was injected to the solution. The mixture was heated to 95° C. and kept for 1 h for reduction. The reaction was then cooled down to room temperature and precipitated in 200 mL DI water. The precipitate was collected by centrifugation and washed with DI water five times. It was then freeze-dried for 48 h and vacuum-dried at 60° C. for 24 h. In another option, double wall carbon nanotubes (DWCNT) was added to the NS-GO/EG before ultrasonic treatment. The purpose of using DWCNT is to minimize the possible agglomeration of the graphene flakes after reduction.

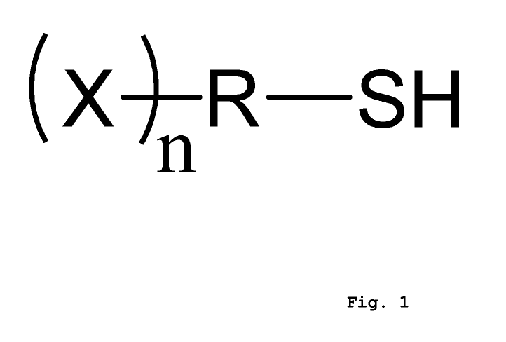

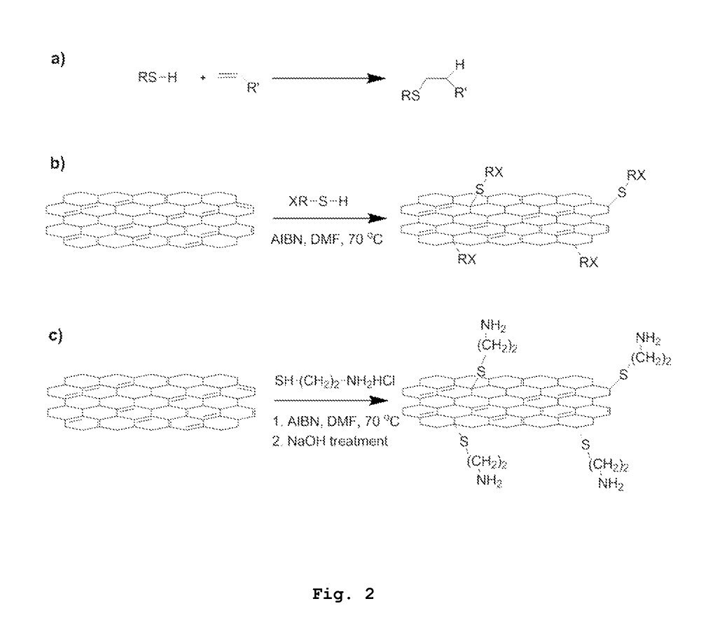

Additionally, DWCNT is used to improve the electrical conductivity of the composites, which could be useful for applications in energy storages. As an example, we used NS-GO/DWCNT with a weight ratio of 70/30 wt % for the samples in FIG. 1b and FIG. 2.

### Results

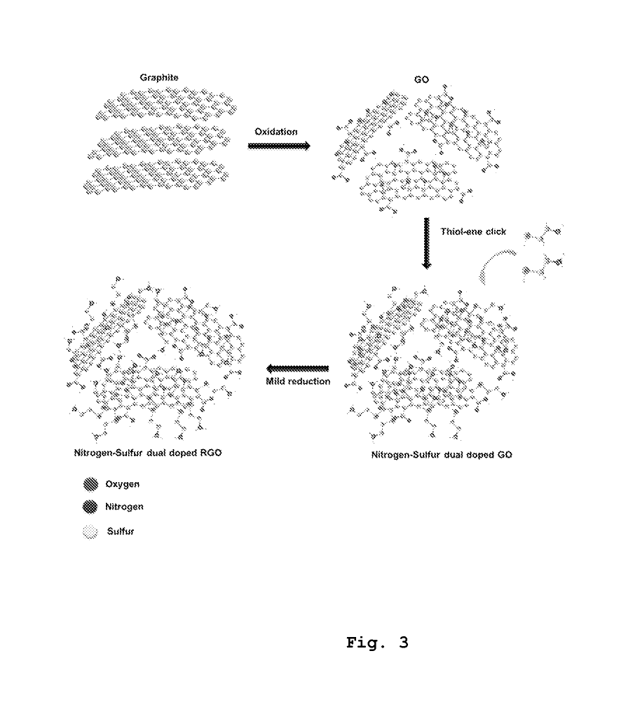

FIGS. 2 and 3 represent the preparation route for the functionalization of GO by thiol-ene click chemistry to form dual doped NS-GO material. The NS-GO is then further reduced by chemical pathway to improve the electrical conductivity of the materials. As seen in Scheme 1, different groups in X can be varied depending on the design.

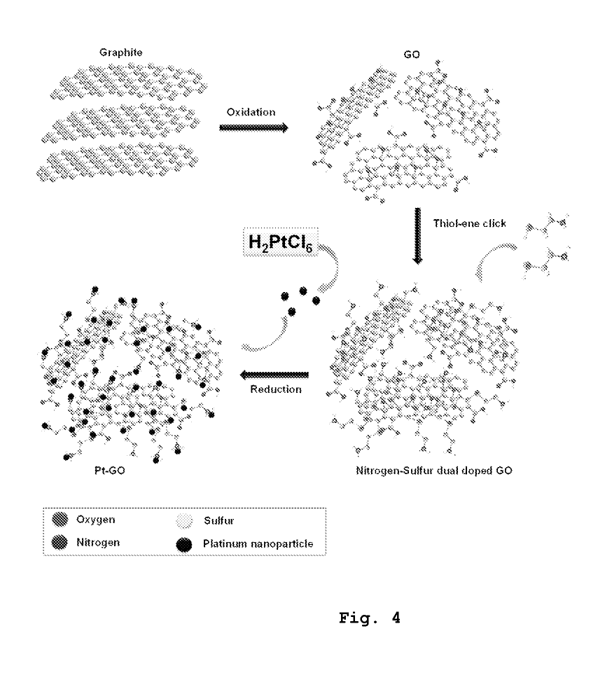

FIG. 4 demonstrate the preparation of NSrGO/Pt composites in which the functional graphene sheets act as support materials for the deposition of Pt nanoparticles. The presence of nitrogen-containing functional groups, such as amine, e.g. in the case of Scheme 1c, is responsible for the uniform distribution of Pt nanoparticles on the graphene sheets.

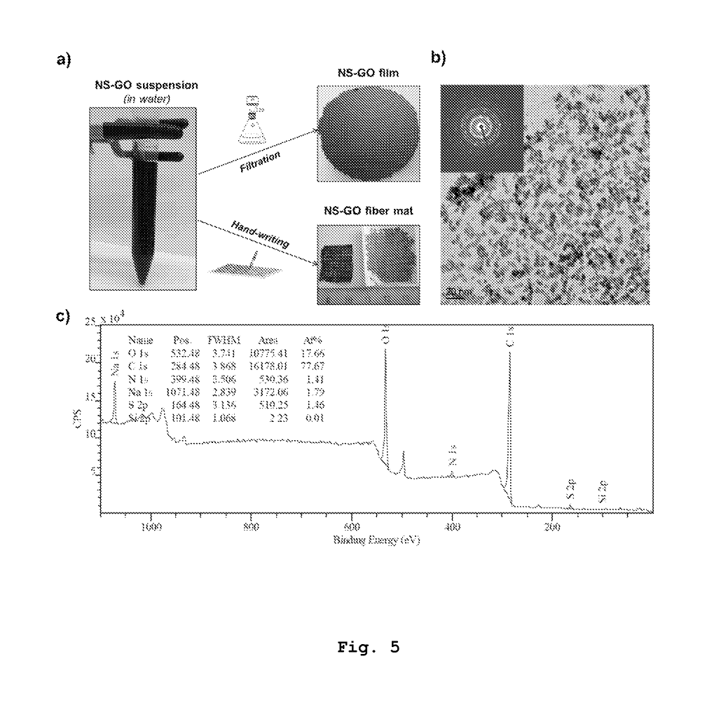

FIG. 5a demonstrates the processibility of the NS-GO material. It can be dispersed uniformly in water. This dispersion was successfully used to fabricate mechanically flexible film and fiber mat.

FIG. 5b is a transmission electron microscopy (TEM) image of the NS-rGO-DWCNT/Pt composites, wherein the NS-GO and DWCNT weight ratio is 70 and 30 wt %, respectively and the Pt content is 38 wt % compared to the carbon weight. The Pt nanoparticles bind strongly and uniformly on the graphene surface, which confirms that sulfur and nitrogen doped sites can promote the chemical absorption of Pt nanoparticles on graphene surface. The X-ray photoelectron spectroscopy (XPS) spectrum of functional graphene is shown in FIG. 5c exhibiting both nitrogen and sulfur characteristic peaks.

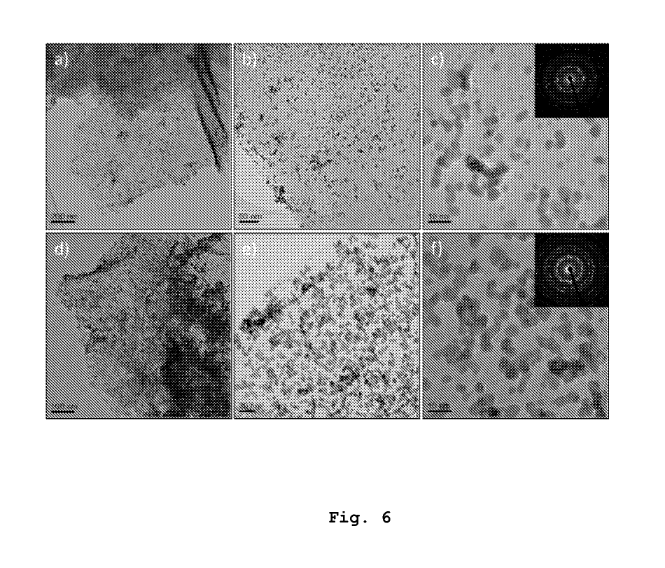

FIG. 6 shows TEM images of two NS-rGODWCNT/Pt composites with different doping levels. FIGS. 6a-c show TEM images of the sample with low doping level and FIGS. 6d-f represent the images of sample with high doping level. It is clear that the sample with high doping level shows much more Pt particles are bound to the graphene surfaces. This phenomenon is due to the fact that nitrogen and sulfurcontaining species have strong ligand coordination interactions with Pt ions and thus stabilizing them during the reduction of Pt ions to Pt metallic particles. As in the high magnification TEMs of NS-rGO-DWCNT/Pt composites, very good dispersion of Pt nanoparticles on graphene surface with an average size of about 3-5 nm have been easily obtained.

We successfully employ thiol-ene reaction for chemical functionalization of GO to form dual N-S doping on GO sheets. The doping level can be controlled by varying the concentration of the reagent, number of S and N atoms in the thiol reagents. It should be noted that the reaction does not require expensive/complicated equipment and harsh conditions. The functionalized NS-GO is dispersible in several common and nontoxic solvents, such as water, ethanol, and ethylene glycol. Flexible paper and fiber can be processed using the developed NS-GO dispersion. In addition, NS-GO has been used effectively as support for Pt nanoparticle deposition, forming even distribution and strong adhesion of Pt particles on graphene surfaces. This developed Pt nanocomposites may be used as catalyst in fuel cells.

The method according to the invention is suitable in different embodiments for forming different kinds of graphene based products.

The invention is not limited merely to the examples referred to above; instead many variations are possible within the scope of the inventive idea defined by the claims.

1. A method for forming graphene based material, wherein graphene oxide is functionalized via thiol-ene click chemistry so that the graphene oxide is prepared and dispersed in solvents, the graphene is reacted with thiol containing compound via thiol-ene click reaction between thiol group and double bond of aromatic rings in graphene oxide by one-step reaction, and the functional graphene oxide is formed.

2. The method according to claim 1, wherein the resulted functional graphene oxide is reduced to electrically conductive and functional graphene.

3. The method according to claim 1, wherein the thiol containing compound has a general structure (X—)ₙ—R—SH, where R is aromatic, aliphatic, ester, ether, amide, imide or a combination thereof, X is NH2, NH3+, —COOH, —OH, —CHO or a combination thereof, and n is in range of 1 to 8.

4. The method according to claim 1, wherein the solvent is selected from the group consisting of water, alcohol, dimethylformamide (DMF), dimethylsulfoxide (DMSO), dimethylacetamide (DMAc), ethers, ketones, chloroform, dichloromethane and their combinations.

5. The method according to claim 1, wherein an initiator is used and the initiator is a thermally initiator.

6. The method according to claim 1, wherein an initiator is used and the initiator is a photo initiator.

7. The method according to claim 1, wherein the reaction is carried out at temperature between 0 to 150° C.

8. The method according to claim 1, wherein the reaction is carried out with radiation of UV.

9. The method according to claim 1, in that wherein the reaction is carried out with radiation of visible light.

10. The method according to claim 1, wherein nitrogen-sulfur dual doped graphene (NS-GO) is formed.

11. The method according to claim 10, wherein nitrogen-sulfur dual doped graphene (NS-GO) is reduced for forming NS-reduced-GO (NS-rGO).

12. The method according to claim 10, wherein NS-reduced-GO (NS-rGO) based composite is formed.

13. The method according to claim 1, wherein the resulted functional graphene is applied in field of polymer composite, catalyst supporter, sensor, energy storage, and water treatment.

14. A graphene based product obtainable by the method according to claim 1.

15. A use of the graphene based product according to claim 14, wherein the graphene based product is used as a final product or as a component in the final product.
